(19) United States
(12) Patent Application Publication
(10) Pub. No.: US 2025/0260795 A1
(43) Pub. Date: Aug. 14, 2025

(54) IMAGE DISPLAY METHOD, IMAGE PROCESSING METHOD, DEVICE AND MEDIUM

(71) Applicant: Beijing Zitiao Network Technology Co., Ltd., Beijing (CN)

(72) Inventors: Haoxiang PENG, Beijing (CN); Guodong GAO, Beijing (CN)

(21) Appl. No.: 18/859,456

(22) PCT Filed: Aug. 18, 2023
(86) PCT No.: PCT/CN2023/113854

§ 371 Date: Oct. 23, 2024

(30) Foreign Application Priority Data
Aug. 19, 2022 (CN) 202210999321.1

(51) Int. Cl. H04N 13/161; G06F 3/04815; H04N 13/15

(52) U.S. Cl. CPC H04N 13/161; G06F 3/04815; H04N 13/15

(57) ABSTRACT

An image display method, an image processing method, a device and a medium are provided. The image display method includes: receiving a two-dimensional image set sent by a server, in which the two-dimensional image set is used for recording two-dimensional images of a three-dimensional object model at a plurality of different viewpoints; in response to a display instruction for the three-dimensional object model at a target viewpoint, parsing a two-dimensional target image corresponding to the target viewpoint from the two-dimensional image set; and displaying the two-dimensional target image.

The present application claims priority of the Chinese Patent Application No. 202210999321.1, filed on Aug. 19, 2022, the disclosure of which is incorporated herein by reference in its entirety as part of the present application.

### TECHNICAL FIELD

Embodiments of the present disclosure relates to an image display method and apparatus, an image processing method and apparatus, a device and a medium.

### BACKGROUND

With the continuous development of computer technology, an increasing number of clients can display three-dimensional object models. To enhance the display effect of three-dimensional object models and improve user interaction experience, the clients need to display two-dimensional images of the three-dimensional object models at a plurality of viewpoints.

To display the two-dimensional images of the three-dimensional object model at the plurality of viewpoints on the client, generally, the three-dimensional object model is directly downloaded and processed, and then the two-dimensional images of the three-dimensional object model at each viewpoint are displayed. However, the spatial information of the three-dimensional object model is complex and needs large memory footprint, directly processing the three-dimensional object model is time-consuming, resulting in poor real-time performance in the display process of the three-dimensional object model and ultimately reducing the users' viewing experience.

### SUMMARY

To solve the above technical problems or at least partially solve the above technical problems, the present disclosure provides an image display method and apparatus, an image processing method and apparatus, a device and a medium.

In the first aspect, the present disclosure provides an image display method applied to a client. The method includes:
receiving a two-dimensional image set sent by a server, in which the two-dimensional image set is used for recording two-dimensional images of a three-dimensional object model at a plurality of different viewpoints;
in response to a display instruction for the three-dimensional object model at a target viewpoint, parsing a two-dimensional target image corresponding to the target viewpoint from the two-dimensional image set; and
displaying the two-dimensional target image.

In the second aspect, the present disclosure provides an image processing method applied to a server. The method includes:
acquiring a two-dimensional image set generated by a three-dimensional object model at a plurality of viewpoints, in which the two-dimensional image set is used for recording two-dimensional images of the three-dimensional object model at a plurality of different viewpoints; and
sending the two-dimensional image set to a client, so that the client parses and displays a two-dimensional target image corresponding to a target viewpoint.

In the third aspect, the present disclosure provides an image display apparatus. The apparatus is configured at a client, and the apparatus includes a receiving module, a parsing module and an image display module. The receiving module is configured to receive a two-dimensional image set sent by a server, in which the two-dimensional image set is used for recording two-dimensional images of a three-dimensional object model at a plurality of different viewpoints. The parsing module is configured to, in response to a display instruction for the three-dimensional object model at a target viewpoint, parse a two-dimensional target image corresponding to the target viewpoint from the two-dimensional image set. The image display module is configured to display the two-dimensional target image.

In the fourth aspect, the present disclosure provides an image processing apparatus. The apparatus is configured at a server, and the apparatus includes an acquiring module and a sending module. The acquiring module is configured to acquire a two-dimensional image set generated by a three-dimensional object model at a plurality of viewpoints, in which the two-dimensional image set is used for recording two-dimensional images of the three-dimensional object model at a plurality of different viewpoints. The sending module is configured to send the two-dimensional image set to a client, so that the client parses and displays a two-dimensional target image corresponding to a target viewpoint.

In the fifth aspect, the present disclosure provides a computer-readable storage medium. Instructions are stored in the computer-readable storage medium, and when the instructions are run on a terminal device, the terminal device is caused to implement the method mentioned above.

In the sixth aspect, the present disclosure provides a device, which includes a memory, a processor and a computer program that is stored in the memory and executable on the processor. When the processor executes the computer program, the processor implements the method mentioned above.

In the seventh aspect, the present disclosure provides a computer program product. The computer program product includes computer programs/instructions, and when the computer programs/instructions are executed by a processor, the processor implements the method mentioned above.

### BRIEF DESCRIPTION OF DRAWINGS

The drawings herein are incorporated into the specification and form part of this description, show the embodiments conforming to the present disclosure and are used together with the description to explain the principles of the present disclosure.

To illustrate the embodiments of the present disclosure more clearly, the drawings required for the embodiments are briefly described below, and it is obvious that for those skilled in the art, other drawings can be obtained from these drawings without creative labor.

FIG. 1 is a flowchart diagram of an image display method according to an embodiment of the present disclosure;

FIG. 2 is a logic diagram of an image display method according to an embodiment of the present disclosure;

FIG. 3 is a flowchart diagram of an image processing method according to an embodiment of the present disclosure;

FIG. 4 is a schematic diagram of acquiring a two-dimensional image according to an embodiment of the present disclosure;

FIG. 5 is a logic diagram of an image processing and display method according to an embodiment of the present disclosure;

FIG. 6 is a structural schematic diagram of an image display apparatus according to an embodiment of the present disclosure;

FIG. 7 is a structural schematic diagram of an image processing apparatus according to an embodiment of the present disclosure; and

FIG. 8 is a structural schematic diagram of a client or server according to an embodiment of the present disclosure.

### DETAILED DESCRIPTION

To provide a clearer understanding of the objectives, features, and advantages of the embodiments of the present disclosure, the solutions in the embodiments of the present disclosure will be further described below. It should be noted that the embodiments in the present disclosure and features in the embodiments may be combined with one another without conflict.

Many specific details are described below to help fully understand the embodiments of the present disclosure. However, the embodiments of the present disclosure may also be implemented in other manners different from those described herein. Apparently, the described embodiments in the specification are merely some rather than all of the embodiments of the present disclosure.

At present, many three-dimensional object models have high definition and texture complexity. When displaying images, the downloading and processing of three-dimensional object models has a high requirement for the network speed and memory, which is difficult to meet the requirement of real-time image display.

To solve the above problems, the embodiments of the present disclosure provide an image display method and apparatus, a device and a medium. The image display method may be applied to a client. Here, the client may include, but not limited to, a mobile phone, a tablet, a notebook computer, a desktop computer, a smart home, a wearable device and a vehicle-mounted device.

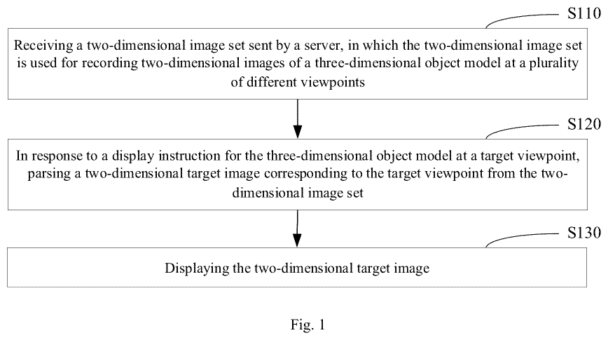

FIG. 1 is a flowchart diagram of an image display method according to an embodiment of the present disclosure. As shown in FIG. 1, the image display method includes the following steps.

S110: receiving a two-dimensional image set sent by a server, in which the two-dimensional image set is used for recording two-dimensional images of a three-dimensional object model at a plurality of different viewpoints.

In practical application, when images need to be displayed, a client downloads and stores the two-dimensional image set from the server. Because the two-dimensional image set records the two-dimensional images of the three-dimensional object model at the plurality of different viewpoints, the two-dimensional image set can provide a two-dimensional image at any viewpoint.

In an embodiment of the present disclosure, the three-dimensional object model may be a three-dimensional model of an object to be displayed.

Alternatively, the three-dimensional object model may have color features, transparency features, or both color features and transparency features.

In an embodiment of the present disclosure, the viewpoint may be understood as screen viewpoint. Specifically, the form of a viewpoint may be latitude and longitude. Here, the latitude range may be [−90, 90] and the longitude range may be [0, 360].

In an embodiment of the present disclosure, the two-dimensional image refers to an image of the three-dimensional object model at any viewpoint.

S120: in response to a display instruction for the three-dimensional object model at a target viewpoint, parsing a two-dimensional target image corresponding to the target viewpoint from the two-dimensional image set.

In practical application, the client acquires the display instruction carrying the target viewpoint from an external input, and then determines the two-dimensional target image corresponding to the target viewpoint based on the two-dimensional image set. Specifically, in response to the two-dimensional image set including two-dimensional images corresponding to the plurality of different viewpoints, the two-dimensional target image corresponding to the target viewpoint can be directly found from the two-dimensional image set; in response to the two-dimensional image set including encoded data of two-dimensional images corresponding to the plurality of different viewpoints, the encoded data corresponding to the target viewpoint is decoded to obtain the two-dimensional target image corresponding to the target viewpoint.

In an embodiment of the present disclosure, the display instruction is a request for triggering the client to display images. Alternatively, the display instruction may be triggered by a user or automatically generated by the client when an application jump occurs.

It should be noted that the three-dimensional object model has highly detailed geometric features, undergoes various reflections and refractions, and has rich and highly complex materials. The two-dimensional images of the three-dimensional object model at the plurality of viewpoints are generated in advance through the server, and the two-dimensional image set for recording the two-dimensional images at the plurality of different viewpoints is generated and then is downloaded to the client, this process eliminates the need for the client to directly download and process the three-dimensional object model. Therefore, the two-dimensional target image corresponding to the target viewpoint can be obtained quickly.

S130: displaying the two-dimensional target image.

In practical application, the client can directly display the two-dimensional target image after determining the two-dimensional target image corresponding to the target viewpoint.

For example, when a user wants to continuously switch the two-dimensional images of a three-dimensional object model on a short video playback interface, a client acquires a target viewpoint corresponding to each switching operation and displays a two-dimensional target image at the target viewpoint corresponding to each switching operation on the short video playback interface.

The embodiment of the present disclosure provides an image display method, which includes the following steps: receiving a two-dimensional image set sent by a server, in which the two-dimensional image set is used for recording two-dimensional images of a three-dimensional object model at a plurality of different viewpoints; in response to a display instruction for the three-dimensional object model at a target viewpoint, parsing a two-dimensional target image corresponding to the target viewpoint from the two-dimensional image set; and displaying the two-dimensional target image. Through the above process, the client can directly determine, from the two-dimensional image set, the two-dimensional target image at the target viewpoint and display it. Since the two-dimensional target image has low complexity and memory usage, the process of displaying an image on the client will not consume excessive network resources or memory, thereby preventing image display stuttered and ultimately improving the users' viewing experience.

In another implementation mode of the present disclosure, the client may acquire, from the two-dimensional image set, the encoded data corresponding to the two-dimensional target image at the target viewpoint, and parse the encoded data to determine the two-dimensional target image.

In the embodiment of the present disclosure, alternatively, S120 may specifically include the following steps.

S1201: from the two-dimensional image set, acquiring encoded data corresponding to the two-dimensional target image at the target viewpoint.

S1202: parsing the encoded data to acquire the two-dimensional target image corresponding to the target viewpoint.

Specifically, since the two-dimensional image set includes the encoded data corresponding to the two-dimensional images of the three-dimensional object model at the plurality of different viewpoints, the client, based on the target viewpoint, first acquires the encoded data corresponding to the two-dimensional target image at the target viewpoint from the two-dimensional image set, and then parses the encoded data by using a decoder such as a h265 decoder to obtain the two-dimensional target image corresponding to the target viewpoint.

Here, the encoded data may be compression encoding products in binary format corresponding to each viewpoint. Specifically, the server performs compression encoding on the two-dimensional images at different viewpoints to obtain the encoded data corresponding to the two-dimensional images at the plurality of different viewpoints in advance.

Therefore, the client only needs to acquire the encoded data corresponding to the two-dimensional target image at the target viewpoint from the two-dimensional image set received by the server and parse the encoded data, so that the two-dimensional target image corresponding to the target viewpoint can be obtained and displayed. Therefore, the image display process only requires the decoding ability of the client, which has a good compatibility and low client requirements for the client. The decoding process is simple, easy to implement, and suitable for mass production, resulting in smaller output files and faster download speeds for the encoded data on the client.

In another implementation mode of the present disclosure, the encoded data includes different types of attribute information, and the different types of attribute information are used to label different types of information, so that the client can display the corresponding two-dimensional target image based on the different types of attribute information.

To ensure the parsing accuracy of encoded data and the accuracy of image display, in some embodiments, the encoded data includes the first attribute information of the two-dimensional images. The size information in the first attribute information includes is used to label a display size of the two-dimensional images, and the target viewpoint is determined according to the viewpoint information in the first attribute information.

Specifically, when parsing the size information from the first attribute information, the client may determine the display size of the two-dimensional image according to the size information. The display size refers to the display dimension of the two-dimensional image. Alternatively, the display size may include length, width, height, etc.

Here, the viewpoint information may be used to label a corresponding viewpoint of the two-dimensional image. Specifically, when parsing the viewpoint information from the first attribute information, the client may determine the target viewpoint according to the viewpoint information.

Therefore, in the embodiment of the present disclosure, the client accurately determines the two-dimensional target image by parsing the viewpoint information in the first attribute information included in the encoded data, and displays the two-dimensional target image with the corresponding size based on the size information in the first attribute information, thus ensuring the parsing accuracy of encoded data and the accuracy of image display.

To enhance the visual effect of image display, color data and transparency data may be fused to generate the two-dimensional target image, satisfying user's needs for viewing both color and transparency. In some embodiments, the encoded data includes the second attribute information of the two-dimensional image, and the second attribute information is used to label position information of different channels of the two-dimensional images in the encoded data.

Accordingly, S1202 may specifically include the following steps.

S12021: acquiring position information of a color channel of the two-dimensional target images in the encoded data and position information of a transparency channel of the two-dimensional target images in the encoded data from the second attribute information.

S12022: acquiring a color channel code corresponding to the target viewpoint from the encoded data according to the position information of the color channel of the two-dimensional target image in the encoded data.

S12023: acquiring a transparency channel code corresponding to the target viewpoint from the encoded data according to the position information of the transparency channel of the two-dimensional target image in the encoded data.

S12024: fusing the color channel code and the transparency channel code to generate the two-dimensional target image corresponding to the target viewpoint.

Here, the position information may be the byte offset and byte length of different channels of the two-dimensional image in the encoded data. That is, the two-dimensional image corresponding to each viewpoint has a corresponding byte offset and byte length, and the encoded data of the two-dimensional image corresponding to each viewpoint includes encoded data of different channels. Therefore, based on the position information of different channels of the two-dimensional target image in the encoded data, the codes of different channels corresponding to the target viewpoint may be obtained from the encoded data.

Here, the color channel may be a YUV channel, and the data corresponding to the color channel is data in YUV format. The color channel code refers to the encoded data corresponding to the color channel of the two-dimensional image.

Specifically, when the server performs compression encoding on the two-dimensional images corresponding to the plurality of viewpoints, the server may first acquire a plurality of RGB images as the two-dimensional images corresponding to the plurality of viewpoints, then extract image data from the YUV channels of the RGB images to obtain image data of the two-dimensional images corresponding to the plurality of viewpoints in the YUV channels, and then perform compression encoding on the image data of the two-dimensional images corresponding to the plurality of viewpoints in the YUV channels to obtain the encoded data of the YUV channels of the two-dimensional images corresponding to the plurality of viewpoints, and the YUV channels of each two-dimensional image correspond to the position information in the encoded data. In this way, after obtaining the encoded data corresponding to the plurality of viewpoints, the client may directly obtain the color channel code corresponding to the target viewpoint from the encoded data according to the position information of the color channel of the two-dimensional target images in the encoded data.

The transparency channel may be an Alpha channel, and the data corresponding to the transparency channel is grayscale data. The transparency channel code refers to the encoded data corresponding to the transparency channel of the two-dimensional image.

Specifically, when the server performs compression encoding on the two-dimensional images corresponding to the plurality of viewpoints, the server may first acquire a plurality of RGB images as the two-dimensional images corresponding to the plurality of viewpoints, then extract image data from the Alpha channels of the RGB images to obtain image data of the two-dimensional images corresponding to the plurality of viewpoints in the Alpha channels, and then perform compression encoding on the image data of the two-dimensional images corresponding to the plurality of viewpoints in the Alpha channels to obtain the encoded data of the Alpha channels of the two-dimensional images corresponding to the plurality of viewpoints, and the Alpha channels of each two-dimensional image correspond to the position information in the encoded data. In this way, after obtaining the encoded data corresponding to the plurality of viewpoints, the client may directly obtain the transparency channel code corresponding to the target viewpoint from the encoded data according to the position information of the transparency channel of the two-dimensional target image in the encoded data.

Further, after obtaining the color channel code and the transparency channel code, the client may fuse the color channel code and the transparency channel code based on a position of a pixel to generate the two-dimensional target image and display it. Therefore, the client can display a two-dimensional target image that is fused with color data and transparency data, so as to meet the user's need for viewing color and transparency.

In other embodiments, the client may also generate and display a two-dimensional target image based only on the color channel code, or the client may also generate and display a two-dimensional target image based only on the transparency channel code. In this way, the client can display a single-channel two-dimensional target image to the user.

It should be noted that two-dimensional images at different viewpoints correspond to different image frame types, which makes the encoded data includes different data frame types, and the acquisition methods of encoded data corresponding to different frame types are different. Therefore, in order to ensure that the encoded data of all data frame types are found, in some embodiments, the encoded data also includes the third attribute information of the two-dimensional image, and the third attribute information is used to label the data frame types of different channels of the two-dimensional images in the encoded data.

Accordingly, S12022 may specifically include the following steps.

S10: according to the third attribute information, acquiring a data frame type of a color channel corresponding to the target viewpoint from the encoded data.

S11: in response to the data frame type of the color channel corresponding to the target viewpoint being a non-key frame type, acquiring a key frame code and a non-key frame code of the color channel corresponding to the target viewpoint from the encoded data according to the position information of the color channel corresponding to the target viewpoint, and generating the color channel code corresponding to the target viewpoint according to the key frame code and non-key frame code of the color channel corresponding to the target viewpoint.

S12: in response to the data frame type of the color channel corresponding to the target viewpoint being a key frame type, acquiring the key frame code of the color channel corresponding to the target viewpoint from the encoded data according to the position information of the color channel corresponding to the target viewpoint, and determining the key frame code of the color channel corresponding to the target viewpoint as the color channel code corresponding to the target viewpoint.

Accordingly, S12023 may specifically include the following steps.

S20: according to the third attribute information, acquiring a data frame type of a transparency channel corresponding to the target viewpoint from the encoded data.

S21: in response to the data frame type of the transparency channel corresponding to the target viewpoint being a non-key frame type, acquiring a key frame code and a non-key frame code of the transparency channel corresponding to the target viewpoint from the encoded data according to the position information of the transparency channel corresponding to the target viewpoint, and generating the transparency channel code corresponding to the target viewpoint according to the key frame code and non-key frame code of the transparency channel corresponding to the target viewpoint.

S22: in response to the data frame type of the transparency channel corresponding to the target viewpoint being a key frame type, acquiring the key frame code of the transparency channel corresponding to the target viewpoint from the encoded data according to the position information of the transparency channel corresponding to the target viewpoint, and determining the key frame code of the transparency channel corresponding to the target viewpoint as the transparency channel code corresponding to the target viewpoint.

Here, the data frame type is a frame type of the two-dimensional image, and the two-dimensional images corresponding to different viewpoints have a unique frame type. The two-dimensional images may include key frame-type images and non-key frame-type images, and the encoded data may include key frame codes and non-key frame codes.

To improve the encoding efficiency of two-dimensional images by the server, the obtained two-dimensional images at the plurality of viewpoints may be divided into groups, and then compression encoding is performed on the two-dimensional images in each group. Specifically, two-dimensional images corresponding to nine continuously spaced viewpoints may be manually grouped together, a centrally positioned two-dimensional image in each group is labeled as a key frame-type two-dimensional image, and the eight non-centrally positioned two-dimensional images in each group are labeled as non-key frame-type two-dimensional images. When performing compression encoding on each group of two-dimensional images, the server may determine the encoded data corresponding to the centrally positioned two-dimensional image in each group as a key frame code, and the encoded data corresponding to the eight non-centrally positioned two-dimensional images in each group as non-key frame codes.

It should be noted that when the server is used to perform compression encoding on each group of two-dimensional images, all compressed codes corresponding to two-dimensional images of key frame type are determined as key frame codes, and part of the compressed codes corresponding to two-dimensional images of non-key frame type are determined as key frame codes, and the other part are determined as non-key frame codes. Therefore, for color channels, when the client acquires the encoded data in different channels corresponding to the target viewpoint, in response to the data frame type of the color channel corresponding to the target viewpoint being non-key frame type, it is required to acquire the key frame codes and non-key frame codes of the color channel corresponding to the target viewpoint, and generate the color channel code corresponding to the target viewpoint according to the non-key frame codes and part of the key frame codes; in response to the data frame type of the color channel corresponding to the target viewpoint being key frame type, the key frame code of the color channel corresponding to the target viewpoint is directly determined as the color channel code corresponding to the target viewpoint.

Here, the key frame code corresponding to the target viewpoint refers to the encoded data of key frames in the group that includes the target viewpoint. The non-key frame code corresponding to the target viewpoint refers to the actual encoded data corresponding to the viewpoint. It should be noted that the principle of determining the transparency channel code is the same as that of determining the color channel code, which will not be repeated here.

To facilitate understanding, the color channel codes and transparency channel codes corresponding to each group of two-dimensional images may be represented as follows:

| | | | |
|---|---|---|---|
| Color channel | IPPPPPPPP | Transparency channel | IPPPPPPPP |
| code | | code | |

The color channel code corresponding to each group of two-dimensional images in the above table includes one key frame (I) code and eight non-key frame (P) codes, and the transparency channel code corresponding to each group of two-dimensional images includes one key frame (I) code and eight non-key frame (P) codes.

Therefore, for different data frame types, encoded data of different data frame types may be acquired based on different logics. For the color channel and the transparency channel, the comprehensiveness and accuracy of the encoded data of the two channels are guaranteed.

To conveniently and quickly acquire encoded data corresponding to different viewpoints, in some embodiments, the encoded data includes a protocol header, and the protocol header includes one of first attribute information, second attribute information and third attribute information, or any combination of the first attribute information, the second attribute information and the third attribute information.

To further improve the efficiency of parsing the encoded data by the client, the client may store the protocol header in the code locally, and then acquire and quickly parse the encoded data from the local storage.

In the embodiment of the present disclosure, alternatively, before S1202, the method further includes the following step:
based on a protocol header format corresponding to each viewpoint, storing the protocol header corresponding to each viewpoint in a preset storage structure.

Accordingly, S1202 may specifically include the following step:
acquiring a target protocol header corresponding to the target viewpoint from the preset storage structure, and parsing encoded data corresponding to the target protocol header to acquire the two-dimensional target image corresponding to the target viewpoint.

Here, the preset storage structure may be a memory storage structure corresponding to the client, specifically a Map structure. The Map is a set that maps key-objects to value-objects, each element of the Map includes a pair of a key-object and a value-object.

Alternatively, the code of the protocol header in the preset storage structure may have the following structure:

{
“Longitude,Latitude”: [
{
“Frame Type”: “I/P”,
“Offset”: “Current Offset”,
“Length”: “Current Frame Length”,
“Alpha_Offset”:“Current Frame Alpha Offset”,
“Alpha_Length”:“Current Frame Alpha length”,
“I_Offset”: “Reference I Frame Offset”,
“I_Length”: “Reference I Frame Length”,
“Alpha_I_Offset”: “Reference I Frame Alpha Offset”,
“Alpha_I_Length”: “Reference I Frame Alpha Length”,
}
}
}

Therefore, in the decoding stage, by parsing the protocol header from the preset storage structure corresponding to the client, the encoded data corresponding to the target viewpoint can be quickly parsed, thereby improving the efficiency of parsing the two-dimensional target image corresponding to the target viewpoint and further optimizing the image display efficiency.

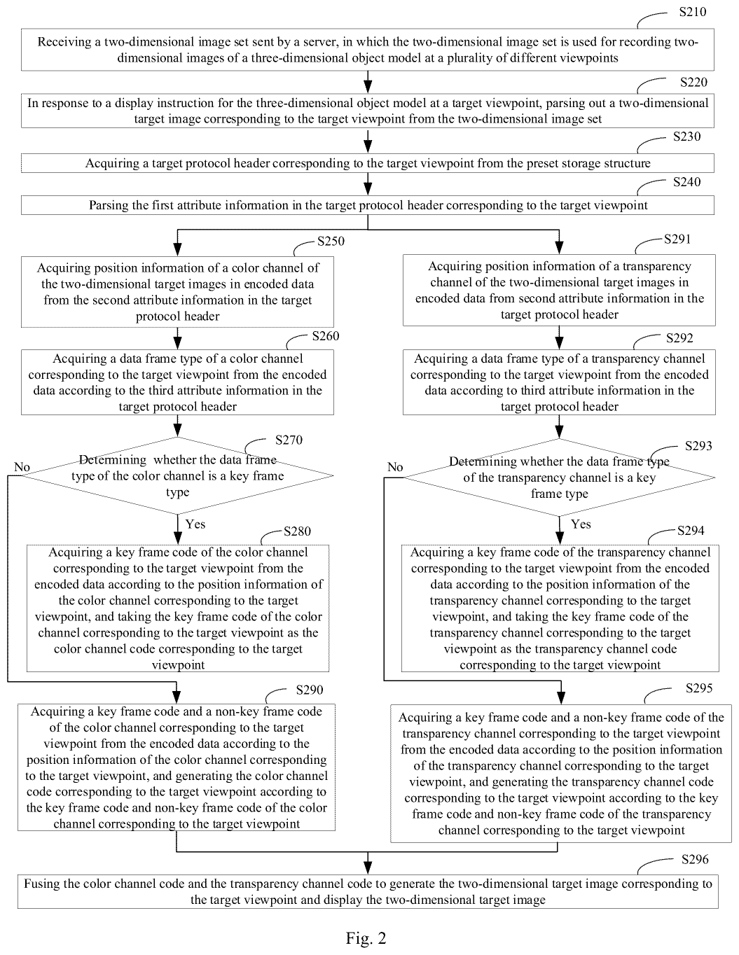

To understand the acquiring the encoded data of different channels corresponding to the target viewpoint from the encoded data, as well as the acquisition logic of the non-key frame type encoded data and the key frame type encoded data, FIG. 2 illustrates a logic diagram of an image display method according to an embodiment of the present disclosure.

As shown in FIG. 2, the image display method includes the following steps.

S210: receiving a two-dimensional image set sent by a server, in which the two-dimensional image set is used for recording two-dimensional images of a three-dimensional object model at a plurality of different viewpoints.

S220: in response to a display instruction for the three-dimensional object model at a target viewpoint, parsing a two-dimensional target image corresponding to the target viewpoint from the two-dimensional image set.

Specifically, before S220, a client may store a protocol header corresponding to each viewpoint in a preset storage structure, such as map, based on a protocol header format corresponding to each viewpoint.

S230: acquiring a target protocol header corresponding to the target viewpoint from the preset storage structure.

S240: parsing the first attribute information in the target protocol header corresponding to the target viewpoint.

The size information in the first attribute information is used to label a display size of the two-dimensional images, and the target viewpoint is determined based on the viewpoint information in the first attribute information.

S250: acquiring position information of a color channel of the two-dimensional target images in encoded data from the second attribute information in the target protocol header.

Here, the second attribute information is used for labeling position information of different channels of the two-dimensional images in the encoded data.

S260: acquiring a data frame type of a color channel corresponding to the target viewpoint from the encoded data according to the third attribute information in the target protocol header.

Here, the third attribute information is used for labeling data frame types of different channels of the two-dimensional images in the encoded data.

S270: determining whether the data frame type of the color channel is a key frame type.

Specifically, in response to the data frame type of the color channel being a key frame type, S280 is executed, otherwise, S290 is executed.

S280: acquiring a key frame code of the color channel corresponding to the target viewpoint from the encoded data according to the position information of the color channel corresponding to the target viewpoint, and determining the key frame code of the color channel corresponding to the target viewpoint as the color channel code corresponding to the target viewpoint.

S290: acquiring a key frame code and a non-key frame code of the color channel corresponding to the target viewpoint from the encoded data according to the position information of the color channel corresponding to the target viewpoint, and generating the color channel code corresponding to the target viewpoint according to the key frame code and non-key frame code of the color channel corresponding to the target viewpoint.

S291: acquiring position information of a transparency channel of the two-dimensional target images in encoded data from second attribute information in the target protocol header.

S292: acquiring a data frame type of a transparency channel corresponding to the target viewpoint from the encoded data according to third attribute information in the target protocol header.

S293: determining whether the data frame type of the transparency channel is a key frame type.

Specifically, in response to the data frame type of the transparency channel being a key frame type, S294 is executed, otherwise, S295 is executed.

S294: acquiring a key frame code of the transparency channel corresponding to the target viewpoint from the encoded data according to the position information of the transparency channel corresponding to the target viewpoint, and determining the key frame code of the transparency channel corresponding to the target viewpoint as the transparency channel code corresponding to the target viewpoint.

S295: acquiring a key frame code and a non-key frame code of the transparency channel corresponding to the target viewpoint from the encoded data according to the position information of the transparency channel corresponding to the target viewpoint, and generating the transparency channel code corresponding to the target viewpoint according to the key frame code and non-key frame code of the transparency channel corresponding to the target viewpoint.

S296: fusing the color channel code and the transparency channel code to generate the two-dimensional target image corresponding to the target viewpoint and display the two-dimensional target image.

In another implementation of the present disclosure, an image processing method for reducing network transmission resources and memory occupation is provided. The image processing method may be applied to a server. Here, the server may be a cloud server or a server cluster.

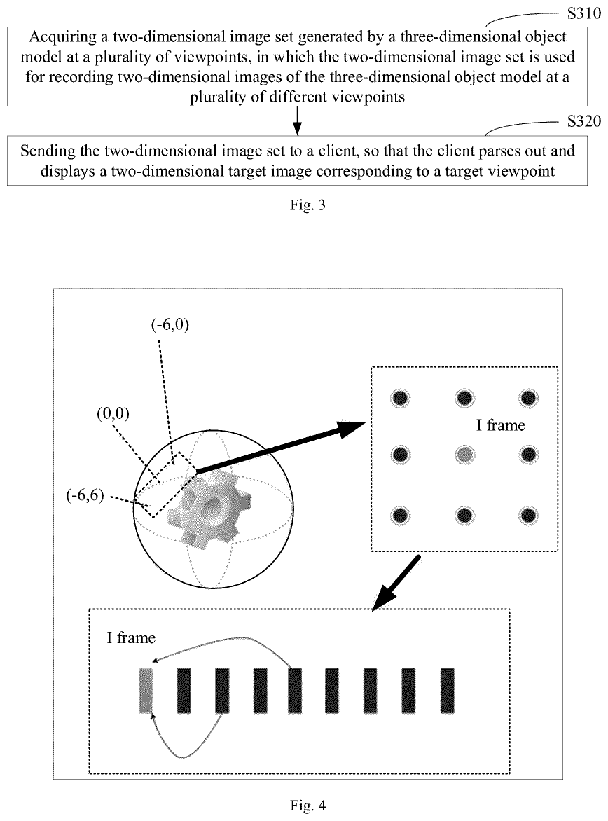

FIG. 3 is a flowchart diagram of an image processing method according to an embodiment of the present disclosure. As shown in FIG. 3, the image processing method includes the following steps.

S310: acquiring a two-dimensional image set generated by a three-dimensional object model at a plurality of viewpoints, in which the two-dimensional image set is used for recording two-dimensional images of the three-dimensional object model at a plurality of different viewpoints.

It can be understood that the viewpoint may be represented by latitude and longitude. Specifically, the latitude range may be [−90, 90] and the longitude range may be [0, 360]. For a three-dimensional object model, one image is captured every 6 degrees, then 360/6*(180/6+1)=1860 two-dimensional images can be captured. These two-dimensional images are divided into groups every 18 degrees, then (180/18+1)*(360/18)=220 groups of two-dimensional images can be acquired. Specifically, excluding the north and south poles, these two-dimensional images can be divided into groups of 3*3, meaning 9 images per group, totally (180/6-1)*(360/6)=1740 two-dimensional images. The centrally positioned two-dimensional image in each group is labeled as a key frame-type image, and the remaining two-dimensional images in each group are labeled as non-key frame-type images. For the north and south poles (*, −90) and (*, 90), 6 images are grouped together in a 3*2 arrangement, the pole is the key frame-type image and the surrounding 5 images are non-key frame-type images, totally 2*(360/6)=120 images.

To understand the acquisition process of two-dimensional images, FIG. 4 illustrates a schematic diagram of acquiring a two-dimensional image.

As shown in FIG. 4, for a three-dimensional object model, one two-dimensional image may be captured every 6 degrees. For example, the two-dimensional image is captured at viewpoints (−6, 6), (0, 0) and (−6, 0), etc., then nine two-dimensional images are obtained and are grouped together. The centrally positioned two-dimensional image in each group is labeled as a key frame-type image, and the non-centrally positioned two-dimensional images in each group are labeled as non-key frame-type images. The key frame-type image in each group of two-dimensional images can serve as a reference for the non-key frame-type images. That is, each group of two-dimensional images includes one key frame-type image and eight non-key frame-type images.

S320: sending the two-dimensional image set to a client, so that the client parses and displays a two-dimensional target image corresponding to a target viewpoint.

In some embodiments, the server may directly send the two-dimensional image set including the two-dimensional images corresponding to the plurality of viewpoints to the client, so that the client can find out the two-dimensional target image corresponding to the target viewpoint from the two-dimensional images and display the two-dimensional target image.

In other embodiments, the server may perform compression encoding on the two-dimensional images corresponding to the plurality of viewpoints to obtain encoded data, obtain the two-dimensional image set that records the two-dimensional images at the plurality of different viewpoints, and send the two-dimensional image set to the client, so that the client can parse the two-dimensional target image corresponding to the target viewpoint and display the two-dimensional target image.

The embodiment of the present disclosure provides an image processing method. The server acquires a two-dimensional image set generated by a three-dimensional object model at a plurality of viewpoints, in which the two-dimensional image set is used for recording two-dimensional images of the three-dimensional object model at the plurality of different viewpoints; and the server sends the two-dimensional image set to a client, so that the client parses and displays a two-dimensional target image corresponding to the target viewpoint. Through the above process, the processing of the three-dimensional object model is executed in the server, so that the client can directly acquire and display the two-dimensional target image corresponding to the target viewpoint. Therefore, displaying the image on the client will not consume excessive network resources or memory, thereby preventing image display stuttered and ultimately improving the interactive experience of the process of users watching the image display.

In another implementation mode of the present disclosure, after performing compression encoding on the two-dimensional images corresponding to the plurality of viewpoints, the server sends encoded data corresponding to the plurality of viewpoints to the client.

In the embodiment of the present disclosure, alternatively, S310 may specifically include the following step:
performing compression encoding on the two-dimensional images corresponding to the plurality of different viewpoints to generate encoded data at the plurality of different viewpoints, and determining the encoded data at the plurality of different viewpoints as the two-dimensional image set.

Specifically, in the process of generating encoded data by the server, the server may use, for example, an h265 encoder to perform compression encoding on the two-dimensional images corresponding to the plurality of different viewpoints, to generate the encoded data corresponding to the two-dimensional images at the plurality of different viewpoints, that is, to generate binary files, and determine the encoded data at the plurality of different viewpoints as the two-dimensional image set.

Alternatively, the encoded data may include parameter codes and a coded body. Here, the parameter codes refer to parameters after encoding two-dimensional images, and the coded body refers to the body of the encoded data.

Alternatively, the parameter codes may include parameters such as video parameter set (VPS_NUT), sequence parameter set (SPS_NUT), picture parameter set (PPS_NUT), etc.

In order to further reduce the resources occupied by the encoded data, only one copy of the above parameter codes may be retained for the encoded data corresponding to the two-dimensional images in each group. In some cases, in response to nine two-dimensional images being grouped together, then the encoded data corresponding to each group of two-dimensional images may be represented as follows:

$$\begin{matrix}Parameter \\ codes\end{matrix} \{ \begin{matrix}0 x 00000000 HEVC Video Parameter Set ( VPS\_NUT ) \\ 0 x 0000001 d HEVC Sequence Parameter Set ( SPS\_NUT ) \\ 0 x 00000049 HEVC Picture Parameter Set ( PPS\_NUT ) \\ 0 x 00000054 HEVC SEI PREFIX ( USER\_data \_unregistered )\end{matrix}$$

$$Coded body \{ \begin{matrix}0 x 00000085 HEVC Slice Header - I \# 0 ( IDR\_w \_RADL ) \\ 0 x 00003862 HEVC Slice Header - P \# 1 ( TRAIL\_R ) \\ 0 x 00005 bac HEVC Slice Header - P \# 2 ( TRAIL\_R ) \\ 0 x 00007 d 45 HEVC Slice Header - P \#3 ( TRAIL\_R ) \\ 0 x 0000 a 6 de HEVC Slice Header - P \# 4 ( TRAIL\_R )\end{matrix}$$

$$Coded body \{ \begin{matrix}0 x 0000 c 68 d HEVC Slice Header - P \# 5 ( TRAIL\_R ) \\ 0 x 0000 e 827 HEVC Slice Header - P \# 6 ( TRAIL\_R ) \\ 0 x 00010 d 38 HEVC Slice Header - P \# 7 ( TRAIL\_R ) \\ 0 x 0012 e 7 a HEVC Slice Header - P \# 8 ( TRAIL\_R )\end{matrix}$$

Therefore, in the embodiment of the present disclosure, the server can perform compression encoding on the two-dimensional images at the plurality of different viewpoints to generate smaller binary files, and send the binary files to the client, so that the client can quickly download the encoded data.

To enable the client to accurately parse the encoded data, the encoded data includes a plurality of attribute information types.

In some embodiments, the encoded data includes the first attribute information of the two-dimensional imaged. The size information in the first attribute information is used to label a display size of the two-dimensional images, and viewpoint information in the first attribute information is used to label the viewpoints of the two-dimensional images.

In other embodiments, the encoded data further include the second attribute information of the two-dimensional images, and the second attribute information is used to label position information of different channels of the two-dimensional images in the encoded data, so that the client can obtain the data of different channels of the two-dimensional image corresponding to the target viewpoint from the encoded data according to the position information.

In still other embodiments, the encoded data further includes the third attribute information of the two-dimensional images, and the third attribute information is used to label the data frame types of different channels of the two-dimensional images in the encoded data, so that the client can decode the data of different channels of the two-dimensional image corresponding to the target viewpoint according to the data frame types.

Further, to conveniently and quickly obtain the encoded data corresponding to different viewpoints, in some embodiments, the server may also add a protocol header to the encoded data of the two-dimensional images corresponding to each viewpoint.

Specifically, the server may add the protocol header to the encoded data of the two-dimensional images corresponding to each viewpoint based on a preset protocol header protocol, and then the encoded data carrying protocol headers are obtained.

Alternatively, the preset header file protocol may be an autoregressive (AR) protocol.

The protocol header may include one of the first attribute information, the second attribute information and the third attribute information, or any combination of the first attribute information, the second attribute information and the third attribute information.

Alternatively, the protocol header may be in the following format:

| | identifier | width | height | data | | | |
|---|---|---|---|---|---|---|---|
| size | 4 bytes | 2 bytes | 2 bytes | 2 bytes | 2 bytes | 1 byte | 4 bytes |
| content | identifier (vear) | width | high | Longitude | Latitude | “i/p” | Frame(offset) |
| description | AR streamer | | | | | Frame type | File offset |
| | identifier | | | | | | Of frame |

Therefore, in the encoding stage, the protocol header can label a plurality of information types of its corresponding encoded data, and for the subsequent decoding stage, the client can quickly obtain the encoded data corresponding to different viewpoints, thus optimizing the image display efficiency.

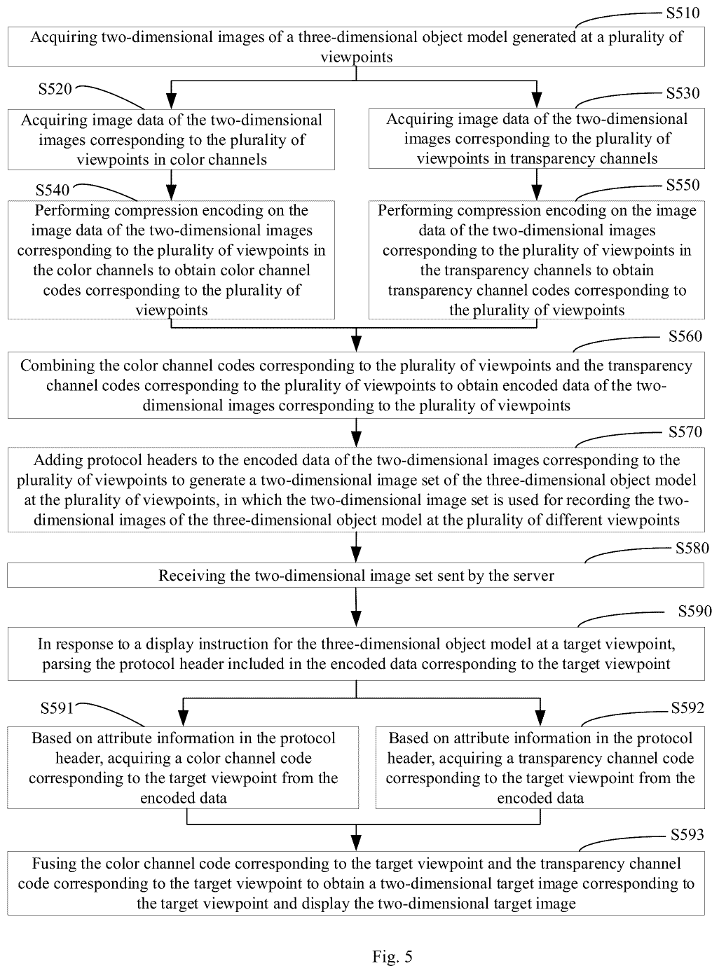

In another implementation mode of the present disclosure, to facilitate the understanding of the image processing process and the image display process, FIG. 5 illustrates a logic diagram of an image processing and display method.

As shown in FIG. 5, the image processing and display method includes the following steps.

S510: acquiring two-dimensional images of a three-dimensional object model generated at a plurality of viewpoints.

S520: acquiring image data of the two-dimensional images corresponding to the plurality of viewpoints in color channels.

S530: acquiring image data of the two-dimensional images corresponding to the plurality of viewpoints in transparency channels.

S540: performing compression encoding on the image data of the two-dimensional images corresponding to the plurality of viewpoints in the color channels to obtain color channel codes corresponding to the plurality of viewpoints.

S550: performing compression encoding on the image data of the two-dimensional images corresponding to the plurality of viewpoints in the transparency channels to obtain transparency channel codes corresponding to the plurality of viewpoints.

S560: combining the color channel codes corresponding to the plurality of viewpoints and the transparency channel codes corresponding to the plurality of viewpoints to obtain encoded data of the two-dimensional images corresponding to the plurality of viewpoints.

S570: adding protocol headers to the encoded data of the two-dimensional images corresponding to the plurality of viewpoints to generate a two-dimensional image set of the three-dimensional object model at the plurality of viewpoints, in which the two-dimensional image set is used for recording the two-dimensional images of the three-dimensional object model at the plurality of different viewpoints.

It should be noted that S510-S570 are all executed by a server.

S580: receiving the two-dimensional image set sent by the server.

S590: in response to a display instruction for the three-dimensional object model at a target viewpoint, parsing the protocol header included in the encoded data corresponding to the target viewpoint.

S591: based on attribute information in the protocol header, acquiring a color channel code corresponding to the target viewpoint from the encoded data.

S592: based on attribute information in the protocol header, acquiring a transparency channel code corresponding to the target viewpoint from the encoded data.

S593: fusing the color channel code corresponding to the target viewpoint and the transparency channel code corresponding to the target viewpoint to obtain a two-dimensional target image corresponding to the target viewpoint and display the two-dimensional target image.

Here, S580-S593 are all executed by the server.

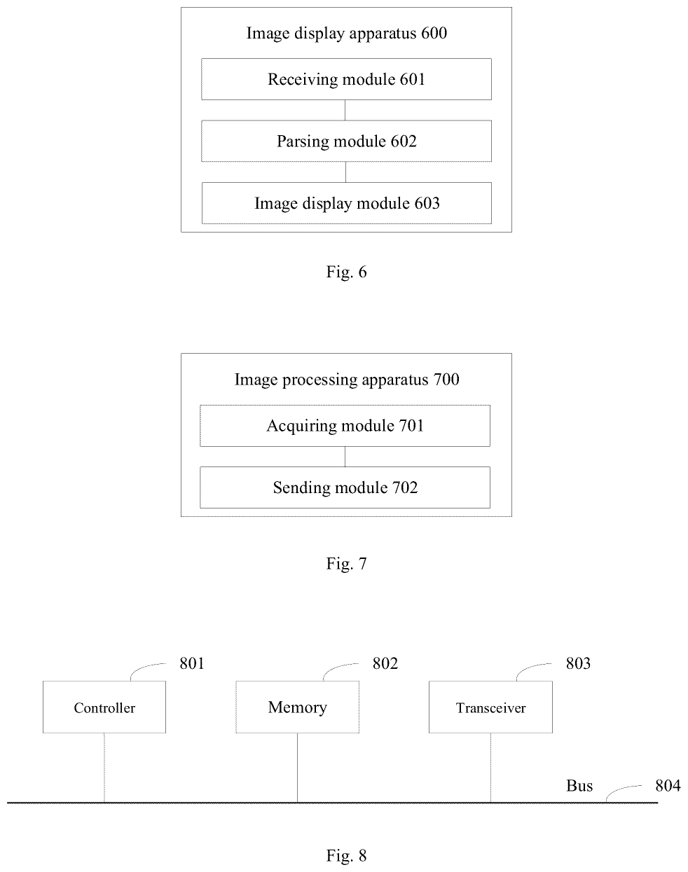

Based on the same inventive concept as the above method embodiment, the present disclosure also provides an image display apparatus, which is configured at a client. Referring to FIG. 6 which is a structural schematic diagram of an image display apparatus provided by an embodiment of the present disclosure, the image display apparatus 600 includes a receiving module 601, a parsing module 602 and an image display module 603.

The receiving module 601 is configured to receive a two-dimensional image set sent by a server, in which the two-dimensional image set is used for recording two-dimensional images of a three-dimensional object model at a plurality of different viewpoints.

The parsing module 602 is configured to, in response to a display instruction for the three-dimensional object model at a target viewpoint, parse a two-dimensional target image corresponding to the target viewpoint from the two-dimensional image set.

The image display module 603 is configured to display the two-dimensional target image.

The embodiment of the present disclosure provides an image display apparatus, which involves the following steps: receiving a two-dimensional image set sent by a server, the two-dimensional image set being used for recording two-dimensional images of a three-dimensional object model at a plurality of different viewpoints; in response to a display instruction for the three-dimensional object model at a target viewpoint, parsing a two-dimensional target image corresponding to the target viewpoint from the two-dimensional image set; and displaying the two-dimensional target image. Through the above process, the client can directly determine, from the two-dimensional image set, the two-dimensional target image at the target viewpoint and display it. Since the two-dimensional target image has low complexity and memory usage, displaying the two-dimensional target image on the client will not consume excessive network resources or memory, thereby preventing image display lag and ultimately improving the users' viewing experience.

In an optional implementation, the parsing module 602 includes an acquiring unit and a parsing unit. The acquiring unit is configured to acquire encoded data corresponding to the two-dimensional target image at the target viewpoint from the two-dimensional image set. The parsing unit is configured to parse the encoded data to acquire the two-dimensional target image corresponding to the target viewpoint.

In an optional implementation, the encoded data includes first attribute information of the two-dimensional images, size information in the first attribute information is used to label a display size of the two-dimensional images, and the target viewpoint is determined according to viewpoint information in the first attribute information.

In an optional implementation, the encoded data includes second attribute information of the two-dimensional images, and the second attribute information is used to label position information of different channels of the two-dimensional images in the encoded data.

Accordingly, the parsing unit is specifically configured to: acquire position information of a color channel of the two-dimensional target image in the encoded data and position information of a transparency channel of the two-dimensional target image in the encoded data from the second attribute information; acquire a color channel code corresponding to the target viewpoint from the encoded data according to the position information of the color channel of the two-dimensional target image in the encoded data; acquire a transparency channel code corresponding to the target viewpoint from the encoded data according to the position information of the transparency channel of the two-dimensional target image in the encoded data; and fuse the color channel code and the transparency channel code to generate the two-dimensional target image corresponding to the target viewpoint.

In an optional implementation, the encoded data further includes third attribute information of the two-dimensional images, and the third attribute information is used to label data frame types of different channels of the two-dimensional images in the encoded data.

Accordingly, the parsing unit is further configured to: acquire a data frame type of a color channel corresponding to the target viewpoint from the encoded data according to the third attribute information; in response to the data frame type of the color channel corresponding to the target viewpoint being a non-key frame type, acquire a key frame code and a non-key frame code of the color channel corresponding to the target viewpoint from the encoded data according to the position information of the color channel corresponding to the target viewpoint, and generate the color channel code corresponding to the target viewpoint according to the key frame code and non-key frame code of the color channel corresponding to the target viewpoint; and in response to the data frame type of the color channel corresponding to the target viewpoint being a key frame type, acquire the key frame code of the color channel corresponding to the target viewpoint from the encoded data according to the position information of the color channel corresponding to the target viewpoint, and determine the key frame code of the color channel corresponding to the target viewpoint as the color channel code corresponding to the target viewpoint.

In an optional implementation, the parsing unit is further configured to: acquire a data frame type of a transparency channel corresponding to the target viewpoint from the encoded data according to the third attribute information; in response to the data frame type of the transparency channel corresponding to the target viewpoint being a non-key frame type, acquire a key frame code and a non-key frame code of the transparency channel corresponding to the target viewpoint from the encoded data according to the position information of the transparency channel corresponding to the target viewpoint, and generate the transparency channel code corresponding to the target viewpoint according to the key frame code and non-key frame code of the transparency channel corresponding to the target viewpoint; and in response to the data frame type of the transparency channel corresponding to the target viewpoint being a key frame type, acquire the key frame code of the transparency channel corresponding to the target viewpoint from the encoded data according to the position information of the transparency channel corresponding to the target viewpoint, and determine the key frame code of the transparency channel corresponding to the target viewpoint as the transparency channel code corresponding to the target viewpoint.

In an optional implementation, the encoded data includes a protocol header, and the protocol header includes one of the first attribute information, the second attribute information and the third attribute information, or any combination of the first attribute information, the second attribute information and the third attribute information.

Based on the same inventive concept as the above method embodiment, the present disclosure also provides an image processing apparatus, which is configured at a server. Referring to FIG. 7, which is a structural schematic diagram of an image processing apparatus provided by an embodiment of the present disclosure, the image processing apparatus 700 includes an acquiring module 701 and a sending module 702.

The acquiring module 701 is configured to acquire a two-dimensional image set generated by a three-dimensional object model at a plurality of viewpoints, in which the two-dimensional image set is used for recording two-dimensional images of the three-dimensional object model at a plurality of different viewpoints.

The sending module 702 is configured to send the two-dimensional image set to a client, so that the client parses and displays a two-dimensional target image corresponding to a target viewpoint.

The embodiment of the present disclosure provides an image processing apparatus, which involves the following steps: acquiring a two-dimensional image set generated by a three-dimensional object model at a plurality of viewpoints, in which the two-dimensional image set is used for recording two-dimensional images of the three-dimensional object model at the plurality of different viewpoints; and sending the two-dimensional image set to a client, so that the client parses and displays a two-dimensional target image corresponding to the target viewpoint. Through the above process, the processing of the three-dimensional object model is executed in the server, so that the client can directly acquire and display the two-dimensional target image corresponding to the target viewpoint. Therefore, displaying the image on the client will not consume excessive network resources or memory, thereby preventing image display stuttered and ultimately improving the interactive experience of the process of users watching the image display

In an optional implementation, the sending module 702 includes a compression encoding unit. The compression encoding unit is configured to perform compression encoding on the two-dimensional images corresponding to the plurality of different viewpoints to generate encoded data at the plurality of different viewpoints, and determine the encoded data at the plurality of different viewpoints as the two-dimensional image set.

In an optional implementation, the encoded data includes first attribute information of the two-dimensional images, and size information in the first attribute information is used to label a display size of the two-dimensional images, and viewpoint information in the first attribute information is used to label viewpoints of the two-dimensional images.

In an optional implementation, the encoded data further includes second attribute information of the two-dimensional images, and the second attribute information is used to label position information of different channels of the two-dimensional images in the encoded data, so that the client, according to the position information, acquires data of different channels of a two-dimensional image corresponding to the target viewpoint from the encoded data.

In an optional implementation, the encoded data further includes third attribute information of the two-dimensional images, and the third attribute information is used to label data frame types of different channels of the two-dimensional images in the encoded data, so that the client, according to the data frame types, decodes data of different channels of the two-dimensional images corresponding to the target viewpoint.

In addition to the above method and apparatus, the embodiments of the present disclosure further provide a computer-readable storage medium. Instructions are stored in the computer-readable storage medium, and when the instructions are run on a terminal device, the terminal device is caused to implement the image display method or the image processing method of the embodiments of the present disclosure.

The embodiments of the present disclosure further provide a computer program product, which includes computer programs/instructions. When the computer programs/instructions are executed by a processor, the processor implements the image display method or the image processing method of the embodiments of the present disclosure.

FIG. 8 illustrates a structural schematic diagram of a client or server according to an embodiment of the present disclosure.

As shown in FIG. 8, the client or server may include controller 801 and memory 802 that stores computer program instructions.

Specifically, the above controller 801 may include a central processing unit (CPU), or an application specific integrated circuit (ASIC), or may be one or more integrated circuits configured to implement the embodiments of the present application.

The memory 802 may include mass memory for information or instructions. For example, rather than as a limitation, the memory 802 may include a hard disk drive (HDD), a floppy disk drive, a flash memory, an optical disc, a magneto-optical disk, a magnetic tape or a Universal Serial Bus (USB) drive, or a combination thereof. In a suitable case, the memory 802 may include a removable or non-removable (or fixed) medium. In a suitable case, the memory 802 may be inside or outside the integrated gateway device. In a specific embodiment, the memory 802 is a non-volatile solid-state memory. In a specific embodiment, the memory 802 includes a read-only memory (ROM). In a suitable case, the ROM may be a mask programmed ROM, a programmable ROM (PROM), an electrical programmable ROM (EPROM), an electrically erasable programmable ROM (EEPROM), an Electrically Alterable ROM (EAROM) or a flash memory, or a combination thereof.

The controller 801 performs a step for the image display method provided in the embodiment of the present disclosure or a step for performing the image processing method provided in the embodiment of the disclosure by reading and executing a computer program instruction stored in memory 802.

The controller 801 executes steps of the image display method provided in the embodiments of the present disclosure or steps of the image processing method provided in the embodiments of the present disclosure by reading and executing the computer program instructions stored in the memory 802.

In an example, the client or server may further include a transceiver 803 and a bus 804. As shown in FIG. 8, the controller 801, the memory 802 and the transceiver 803 are connected through the bus 804 and complete communication with each other.

The bus 804 includes hardware, software, or both. For example, rather than as a limitation, the bus may include an Accelerated Graphics Port (AGP) or other graphics bus, an Extended Industry Standard Architecture (EISA) bus, a Front Side Bus (FSB), a Hyper Transport (HT) interconnect, an Industrial Standard Architecture (ISA) bus, an unlimited bandwidth interconnect, a Low Pin Count (LPC) bus, a memory bus, a Micro Channel Architecture (MCA) bus, a Peripheral Component Interconnect (PCI) bus, a PCI-Express (PCI-X) bus, a Serial Advanced Technology Attachment (SATA) bus, a Video Electronics Standards Association Local Bus (VLB) bus, or other suitable bus, or a combination of two or more of these. In a suitable case, the bus 804 may include one or more buses. Although the embodiments of the present application describe and illustrate a particular bus, the present application contemplates any suitable bus or interconnection.

It should be noted that in this article, relational terms such as “first” and “second” are used solely to distinguish one entity or operation from another, and do not necessarily require or imply any such actual relationship or sequence between those entities or operations. Further, the term “including”, “comprising” or any other variation thereof is intended to cover non-exclusive inclusion so that a process, method, object or device that includes a series of elements includes not only those elements, but also other elements that are not expressly listed, or further includes the elements that are inherent to the process, method, object or device. In the absence of more restrictions, an element defined by the statement “including a . . . ” does not preclude the existence of another identical element in the process, method, article or apparatus that includes the element.

The above is only the specific embodiments of the present disclosure, so that those skilled in the art can understand or realize the present disclosure. The various modifications to these embodiments will be obvious to those skilled in the art, and the general principles defined herein may be implemented in other embodiments without departing from the spirit or scope of the present disclosure. Accordingly, the present disclosure will not be limited to these embodiments herein, but will conform to the widest range consistent with the principles and novelties disclosed herein.

1. An image display method applied to a client, comprising:
receiving a two-dimensional image set sent by a server, wherein the two-dimensional image set is used for recording two-dimensional images of a three-dimensional object model at a plurality of different viewpoints;
in response to a display instruction for the three-dimensional object model at a target viewpoint, parsing a two-dimensional target image corresponding to the target viewpoint from the two-dimensional image set; and
displaying the two-dimensional target image.

2. The image display method according to claim 1, wherein the parsing a two-dimensional target image corresponding to the target viewpoint from the two-dimensional image set, comprises:
acquiring encoded data corresponding to the two-dimensional target image at the target viewpoint from the two-dimensional image set; and
parsing the encoded data to acquire the two-dimensional target image corresponding to the target viewpoint.

3. The image display method according to claim 2, wherein the encoded data comprises first attribute information of the two-dimensional images, size information in the first attribute information is used to label a display size of the two-dimensional images, and the target viewpoint is determined according to viewpoint information in the first attribute information.

4. The image display method according to claim 2, wherein the encoded data comprises second attribute information of the two-dimensional images, and the second attribute information is used to label position information of different channels of the two-dimensional images in the encoded data; and
accordingly, the parsing the encoded data to acquire the two-dimensional target image corresponding to the target viewpoint, comprises:
acquiring position information of a color channel of the two-dimensional target image in the encoded data and position information of a transparency channel of the two-dimensional target image in the encoded data from the second attribute information;
acquiring a color channel code corresponding to the target viewpoint from the encoded data according to the position information of the color channel of the two-dimensional target image in the encoded data;
acquiring a transparency channel code corresponding to the target viewpoint from the encoded data according to the position information of the transparency channel of the two-dimensional target image in the encoded data; and
fusing the color channel code and the transparency channel code to generate the two-dimensional target image corresponding to the target viewpoint.

5. The image display method according to claim 4, wherein the encoded data further comprises third attribute information of the two-dimensional images, and the third attribute information is used to label data frame types of different channels of the two-dimensional images in the encoded data; and
accordingly, the acquiring a color channel code corresponding to the target viewpoint from the encoded data according to the position information of the color channel, comprises:
according to the third attribute information, acquiring a data frame type of a color channel corresponding to the target viewpoint from the encoded data;
in response to the data frame type of the color channel corresponding to the target viewpoint being a non-key frame type, acquiring a key frame code and a non-key frame code of the color channel corresponding to the target viewpoint from the encoded data according to the position information of the color channel corresponding to the target viewpoint, and generating the color channel code corresponding to the target viewpoint according to the key frame code and non-key frame code of the color channel corresponding to the target viewpoint; and
in response to the data frame type of the color channel corresponding to the target viewpoint being a key frame type, acquiring the key frame code of the color channel corresponding to the target viewpoint from the encoded data according to the position information of the color channel corresponding to the target viewpoint, and determining the key frame code of the color channel corresponding to the target viewpoint as the color channel code corresponding to the target viewpoint.

6. The image display method according to claim 5, wherein the acquiring a transparency channel code corresponding to the target viewpoint from the encoded data according to the position information of the transparency channel, comprises:
according to the third attribute information, acquiring a data frame type of a transparency channel corresponding to the target viewpoint from the encoded data;
in response to the data frame type of the transparency channel corresponding to the target viewpoint being a non-key frame type, acquiring a key frame code and a non-key frame code of the transparency channel corresponding to the target viewpoint from the encoded data according to the position information of the transparency channel corresponding to the target viewpoint, and generating the transparency channel code corresponding to the target viewpoint according to the key frame code and non-key frame code of the transparency channel corresponding to the target viewpoint; and
in response to the data frame type of the transparency channel corresponding to the target viewpoint being a key frame type, acquiring the key frame code of the transparency channel corresponding to the target viewpoint from the encoded data according to the position information of the transparency channel corresponding to the target viewpoint, and determining the key frame code of the transparency channel corresponding to the target viewpoint as the transparency channel code corresponding to the target viewpoint.

7. The image display method according to claim 2, wherein the encoded data comprises a protocol header, and the protocol header comprises one of a first attribute information, a second attribute information and a third attribute information, or any combination of the first attribute information, the second attribute information and the third attribute information.

8. An image processing method applied to a server, comprising:
acquiring a two-dimensional image set generated by a three-dimensional object model at a plurality of viewpoints, wherein the two-dimensional image set is used for recording two-dimensional images of the three-dimensional object model at a plurality of different viewpoints; and
sending the two-dimensional image set to a client, so that the client parses and displays a two-dimensional target image corresponding to a target viewpoint.

9. The image processing method according to claim 8, wherein the acquiring a two-dimensional image set generated by a three-dimensional object model at a plurality of viewpoints, comprises:
performing compression encoding on the two-dimensional images corresponding to the plurality of different viewpoints to generate encoded data at the plurality of different viewpoints, and determining the encoded data at the plurality of different viewpoints as the two-dimensional image set.

10. The image processing method according to claim 9, wherein the encoded data comprises first attribute information of the two-dimensional images, and size information in the first attribute information is used to label a display size of the two-dimensional images, and viewpoint information in the first attribute information is used to label viewpoints of the two-dimensional images.

11. The image processing method according to claim 9- or 10, wherein the encoded data further comprises second attribute information of the two-dimensional images, and the second attribute information is used to label position information of different channels of the two-dimensional images in the encoded data, so that the client, according to the position information, acquires data of different channels of a two-dimensional image corresponding to the target viewpoint from the encoded data.

12. The image processing method according to claim 9, wherein the encoded data further comprises third attribute information of the two-dimensional images, and the third attribute information is used to label data frame types of different channels of the two-dimensional images in the encoded data, so that the client, according to the data frame types, decodes data of different channels of the two-dimensional images corresponding to the target viewpoint.

13-14. (canceled)

15. A non-transitory computer-readable storage medium, wherein instructions are stored in the non-transitory computer-readable storage medium, and when the instructions are run on a terminal device, the terminal device is caused to implement the image display method according to claim 1.

16. A device, comprising at least one memory, at least one processor and a computer program that is stored in the at least one memory and executable on the at least one processor, wherein when the at least one processor executes the computer program, the at least one processor implements an image display method, wherein the image display method is applied to a client, and comprises:
receiving a two-dimensional image set sent by a server, wherein the two-dimensional image set is used for recording two-dimensional images of a three-dimensional object model at a plurality of different viewpoints;
in response to a display instruction for the three-dimensional object model at a target viewpoint, parsing a two-dimensional target image corresponding to the target viewpoint from the two-dimensional image set; and
displaying the two-dimensional target image;
wherein the image processing method is applied to the server, and comprises:
acquiring the two-dimensional image set generated by the three-dimensional object model at the plurality of different viewpoints; and
sending the two-dimensional image set to the client, so that the client parses and displays the two-dimensional target image corresponding to the target viewpoint.

17. (canceled)

18. The device according to claim 16, wherein the parsing a two-dimensional target image corresponding to the target viewpoint from the two-dimensional image set, comprises:
acquiring encoded data corresponding to the two-dimensional target image at the target viewpoint from the two-dimensional image set; and
parsing the encoded data to acquire the two-dimensional target image corresponding to the target viewpoint.

19. The device according to claim 18, wherein the encoded data comprises first attribute information of the two-dimensional images, size information in the first attribute information is used to label a display size of the two-dimensional images, and the target viewpoint is determined according to viewpoint information in the first attribute information.

20. The device according to claim 18, wherein the encoded data comprises second attribute information of the two-dimensional images, and the second attribute information is used to label position information of different channels of the two-dimensional images in the encoded data; and
accordingly, the parsing the encoded data to acquire the two-dimensional target image corresponding to the target viewpoint, comprises:
acquiring position information of a color channel of the two-dimensional target image in the encoded data and position information of a transparency channel of the two-dimensional target image in the encoded data from the second attribute information;
acquiring a color channel code corresponding to the target viewpoint from the encoded data according to the position information of the color channel of the two-dimensional target image in the encoded data;
acquiring a transparency channel code corresponding to the target viewpoint from the encoded data according to the position information of the transparency channel of the two-dimensional target image in the encoded data; and
fusing the color channel code and the transparency channel code to generate the two-dimensional target image corresponding to the target viewpoint.

21. The device according to claim 20, wherein the encoded data further comprises third attribute information of the two-dimensional images, and the third attribute information is used to label data frame types of different channels of the two-dimensional images in the encoded data; and
accordingly, the acquiring a color channel code corresponding to the target viewpoint from the encoded data according to the position information of the color channel, comprises:
according to the third attribute information, acquiring a data frame type of a color channel corresponding to the target viewpoint from the encoded data;
in response to the data frame type of the color channel corresponding to the target viewpoint being a non-key frame type, acquiring a key frame code and a non-key frame code of the color channel corresponding to the target viewpoint from the encoded data according to the position information of the color channel corresponding to the target viewpoint, and generating the color channel code corresponding to the target viewpoint according to the key frame code and non-key frame code of the color channel corresponding to the target viewpoint; and
in response to the data frame type of the color channel corresponding to the target viewpoint being a key frame type, acquiring the key frame code of the color channel corresponding to the target viewpoint from the encoded data according to the position information of the color channel corresponding to the target viewpoint, and determining the key frame code of the color channel corresponding to the target viewpoint as the color channel code corresponding to the target viewpoint.

22. The device according to claim 21, wherein the acquiring a transparency channel code corresponding to the target viewpoint from the encoded data according to the position information of the transparency channel, comprises:
according to the third attribute information, acquiring a data frame type of a transparency channel corresponding to the target viewpoint from the encoded data;
in response to the data frame type of the transparency channel corresponding to the target viewpoint being a non-key frame type, acquiring a key frame code and a non-key frame code of the transparency channel corresponding to the target viewpoint from the encoded data according to the position information of the transparency channel corresponding to the target viewpoint, and generating the transparency channel code corresponding to the target viewpoint according to the key frame code and non-key frame code of the transparency channel corresponding to the target viewpoint; and
in response to the data frame type of the transparency channel corresponding to the target viewpoint being a key frame type, acquiring the key frame code of the transparency channel corresponding to the target viewpoint from the encoded data according to the position information of the transparency channel corresponding to the target viewpoint, and determining the key frame code of the transparency channel corresponding to the target viewpoint as the transparency channel code corresponding to the target viewpoint.

23. The device according to claim 16, wherein the acquiring the two-dimensional image set generated by the three-dimensional object model at the plurality of different viewpoints, comprises:
performing compression encoding on the two-dimensional images corresponding to the plurality of different viewpoints to generate encoded data at the plurality of different viewpoints, and determining the encoded data at the plurality of different viewpoints as the two-dimensional image set.
